(19) United States
(12) Patent Application Publication
(10) Pub. No.: US 2013/0181471 A1
(43) Pub. Date: Jul. 18, 2013

(54) CART

(71) Applicant: Steven Russell Tucker, St. John's (CA)

(72) Inventor: Steven Russell Tucker, St. John's (CA)

(21) Appl. No.: 13/554,107

(22) Filed: Jul. 20, 2012

Related U.S. Application Data
(60) Provisional application No. 61/510,345, filed on Jul. 21, 2011.

(51) Int. Cl. A61G 1/02

(52) U.S. Cl. CPC A61G 1/02
USPC 296/20

(57) ABSTRACT

This invention relates to a cart (hand cart, dolley) for the safe transport of an elongated load in a horizontal position; and in particular to carts for transporting spinal boards, rescue stretchers, rescue baskets, full body vacuum splits and similar loads and their passengers in a horizontal position, where the wheels can be repositioned horizontally along the cart to facilitate loading and then for improved balance and cart mobility on stairs, narrow hallways and uneven terrain. Other elongated load, including sea kayaks, surfboards, construction materials, etc., may also be transported by a cart of the nature disclosed. The wheels may also be mounted on a hinged strut, which permits the wheels to swing fully out from under the cart during loading and then back under the cart during operation. Shock absorbers along the strut and/or the wheel mounts may permit a balanced horizontal transport with a smooth ride even on rough or uneven terrain.

### FIELD

The present invention relates to a wheeled apparatus for transporting elongated loads by hand and in particular carts for transporting spinal boards, rescue stretchers, rescue baskets, full body vacuum splits and similar loads and their passengers, including people and bodies.

### BACKGROUND

Various devices exist to facilitate the hand transport of objects, including carts, dollies, trolleys, trailers, wagons, hand trucks, wheeled platforms, etc. (generally, carts). Common objects may be fitted with such carts or carts may be adapted for use with particular objects.

Spinal board, spine boards, back boards rescue baskets, rescue stretchers and even full body vacuum splints, (each of these specific “elongated loads” for use with or without injured persons or bodies referred to herein as spinal boards without loss of generality) are used for the safe transport of persons with injuries from an accident site to a rescue vehicle or for the extraction or transport of bodies.

While various wheeled cart assemblies exist to facilitate the transport of elongated loads generally, carts for spinal boards and other rescue purposes, either to permit use by a single person or to facilitate use by multiple people, have different requirements in terms or strength, resilience, and positioning so as to prevent further damage to the load being carried, and for this reason not all carts are adapted for the purpose of spinal board transport. References to existing devices in this specification are not meant as any admission that such references are either widely known or form part of common general knowledge in the field, or that cart assemblies used outside the safety rescue industry would be applicable to or known in that industry.

### SUMMARY

The current disclosure relates to a cart for use with a spine board comprising a frame having a plurality of horizontal operating positions (defined either by one track/guide or a plurality of parallel tracks/guides, or pin holes at set positions on the frame), and a carriage assembly mounted thereon which may be positioned at the plurality of horizontal operating or loading positions along the track/guide such that the carriage assembly is below the frame during operation, but may be securely set in various operating or loading positions by sliding the frame and carriage assembly relative to each other.

Optionally, the supports which join the carriage assembly to the frame are telescoping, so as to permit a plurality of set operating heights to be used, thereby providing additional robustness for transport on stairs, uneven surfaces or on inclines, while still maintaining substantially horizontal positioning of the spinal board in use.

The main strut extends to a pivot point (a hinge, axel, pin connection, etc.) at one end of the carriage assembly, and is able to provide shock absorption for a wheel assembly.

The present invention is a cart assembly for use with a spinal board or other elongated load, and optionally detachably attachable to such elongated load, comprising an elongated frame for receiving the elongated load, having a track for a carriage assembly, and a carriage assembly capable of moving relative to the track, such that in an operating state, the wheels may be positioned in a plurality of locations relative to the frame. The frame may be telescoping to provide ease of storage and transport. The track may be provided with an operating distance along the entire length frame, or only from one end of the frame to some point along the frame, the position of which could represent the midpoint of the spinal board positioned thereon. In a non-operating state, the carriage assembly may be capable of rotating out past the end of the frame to permit the assembled spinal board and cart assembly to lie flat on the ground in a non-operating loading position. Or, alternatively, the carriage assembly may be generally fixed in place. In a loading operating position, the wheels of the carriage assembly and either or both of the foot of the spinal board or the foot end of the cart frame may be tipped into a stable loading tripod position. The frame may also be provided with handles, and the carriage assembly with a braking mechanism operated from an activator on or proximate to the handles.

### BRIEF DESCRIPTION OF THE DRAWINGS

FIG. 1 shows a top view of a cart with a transparent spinal board positioned above. Certain of the other figures noted below are based on different view of this embodiment.

FIG. 2 shows a side view of the cart of FIG. 1 in the direction A-A of FIG. 1.

FIG. 3 shows a cross sectional rear view (towards the feet) of the cart of FIG. 1 in the elevation B of FIG. 2.

FIG. 4 shows a bottom view of the cart of FIG. 1 in the elevation C-C of FIG. 2.

FIG. 5 shows a perspective view of a cart in an operating position.

FIG. 6 shows a perspective view of the cart of FIG. 5 in a loading position.

### DETAILED DESCRIPTION

Certain embodiments of the present invention will now be described in greater detail with reference to the accompanying drawings. Without limiting the generality of the application of the present invention to the spinal board shown, a device of the present device may be adapted to a general elongated load, or specific elongated loads for use or in cooperation therewith, without departing from the present invention. The specific elongated loads could include spinal boards (including passengers or bodies thereon), surfboards, kayaks, sailboats, trees, construction materials, appliances, etc.

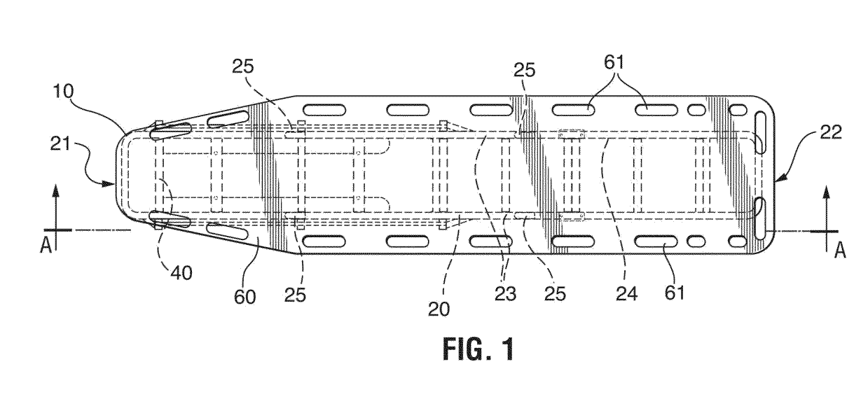

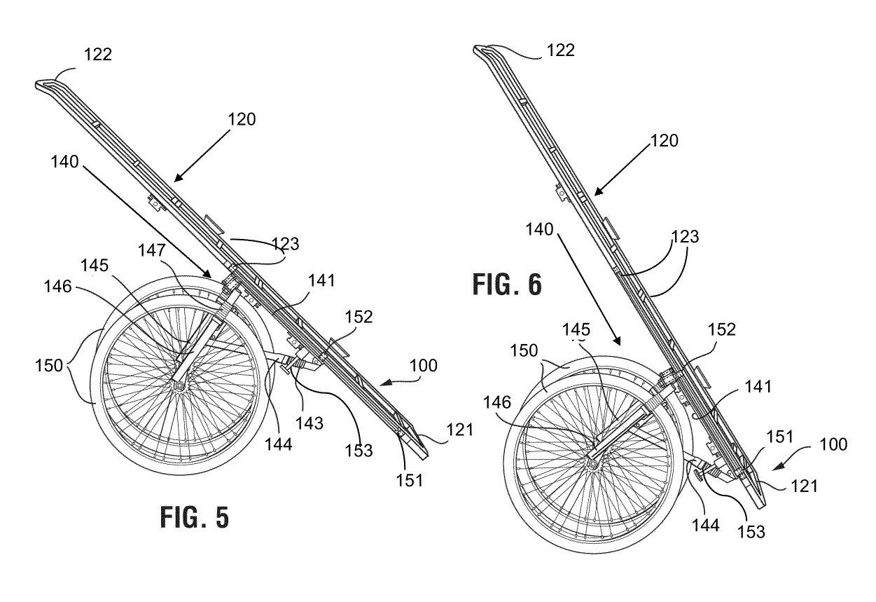

FIG. 1 shows a top view of a cart 10 having a frame 20 and a carriage assembly 40. The frame 20 is comprised of a resilient high strength tube frame having a foot end 21 and a head end 22. The frame 20 is provided with parallel carriage guides 23 and 24, for slidable attachment with the carriage assembly 40. Spinal board attachment pegs 25 or straps are optionally provided at various positions along the frame, to detachably affix a spinal board 60 (which need not be included) in a safe and secure position on the frame, possibly, at the hand holds 61 of the spinal board. The frame 20 may also feature a plurality of lock positions (shown in the example of FIG. 5 and FIG. 6) to secure the horizontal position of the wheel assembly in two or more positions along the carriage guides 23 and 24.

Optionally, guide pegs are also provided for use with particular spinal boards which have standard grooves on the bottom side to assist in positioning. Given that spinal boards tend to have redundant hand holds, various affixing mechanisms can be used, including custom sized pegs to completely fill two or more of the hand holds, such as hand holds or Velcro™ based straps to tighten a spinal board or other elongated load in place.

In another embodiment of the cart, generalized attachment pegs or straps are provided at various positions along the frame, to detachably affix other suitable elongated loads (not part of the invention) in a safe and secure position on the frame.

As discussed with respect to FIGS. 5 and 6 below, the frame may also feature a plurality of lock positions to secure the horizontal position of the wheel assembly in two or more positions along the carriage guides. The frame may be provided with optional features. In the embodiment shown, the head end of the frame telescopes from the foot end and locks into place in a fully extend operational mode. The frame may also be provided with a brake lever, or shaped handles. Locking pins or other clasping or restraining means may be used to secure the wheel assemble in lock positions along the carriage guides/tracks.

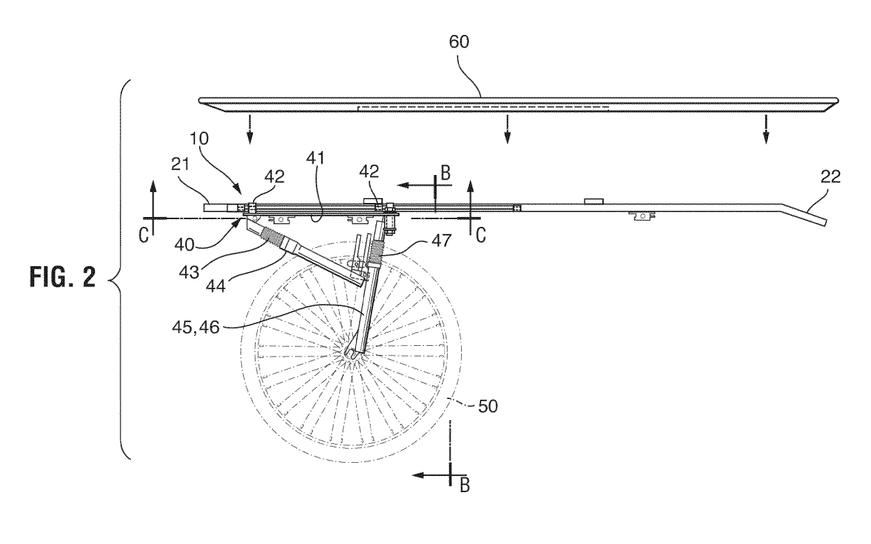

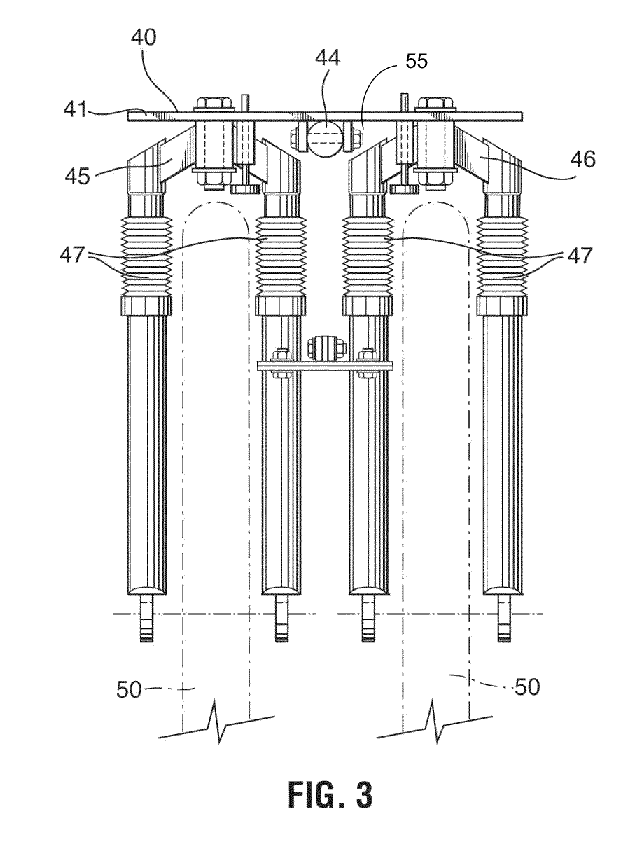

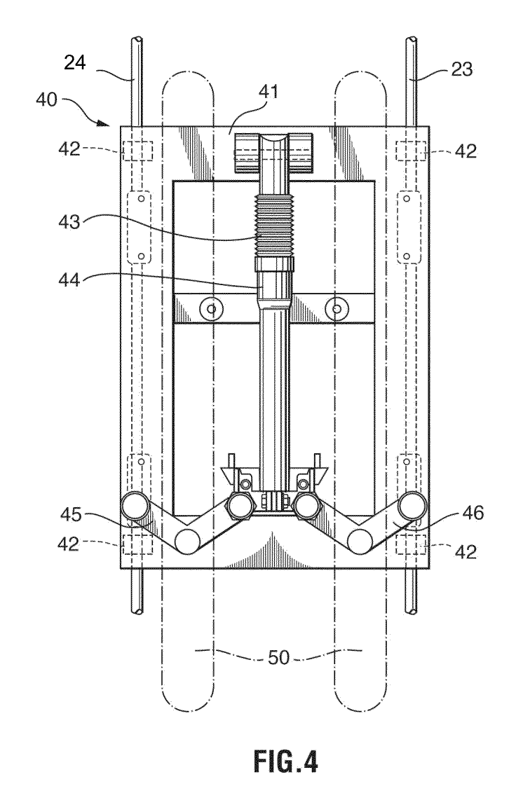

As shown in various views of FIG. 2, FIG. 3 and FIG. 4, the carriage assembly 40 is preferably constructed using a plate 41 having guide sleeves 42 for slidable attachment to carriage guides 23 and 24 respectively, and lying within the frame 20. A strut 44 is pivotally attached towards the portion of the plate 41 proximate to the foot end 21 of the frame at one end, and firmly attached to wheel mounts 45 and 46 at the other end. The joint may be a bar 55 connecting the strut 44 and the wheel mounts 45 and 46. The wheel mounts 45 and 46 are provided with shock absorbers 47 for biased engagement with the plate 41 and permit secure engagement with wheels 50. Alternatively, other known shock absorbing configurations, including a resilient spring biasing a main strut from the rest of the load bearing portion of the cart may be used (as is seen in some mountain bike designs).

As shown in FIGS. 1, 2, 3 and 4, the carriage guides are cylinders and the carriage assembly is slidably attached thereto by tube shaped guide sleeves which fit around the cylinders. Alternatively, the carriage guides are hollow rail sleeves and the carriage assembly is attached thereto by rail means slidably fitted within the rail sleeves. In a further example, the carriage guides are parallel runners adapted to receive the edges of the carriage plate itself.

In an optional configuration, the strut 44 may act as a swing arm to position the wheels 50 out from under the frame while loading an elongated load onto the cart 10. Lifting the cart 10, allows the piston mount to swing back under the frame to permit the wheel mounts 45 and 46 to abut the plate 41 during use. The wheel mounts may also be affixed to the plate in a less robust embodiment of the invention, or may clip into place. Optionally, the strut 44 has an additional shock absorber 43 comprised within it, or is resiliently biased away from the plate in the direction of pivot by a spring (not shown in these figures).

The wheels 50, are preferably each over 20 cm in diameter to facilitate stair climbing and use on mixed terrain, and wheel mounts 45 and 46 shown are standard bicycle front wheel forks.

FIG. 5 shows a perspective view of another cart 100, having a telescoping frame 120 and a carriage assembly 140. The frame 120 is comprised of a resilient high strength tube frame having a foot end 121 and a head end 122 , and parallel carriage guide rails 123. The carriage assembly 140 is provided with plate 141 slideably connected with the carriage guide rails 123, which may be affixed at a plurality of lock points of which a first lock point 151 and a second lock point 152 are shown, using a locking pin 153. The carriage assembly is also provided with wheels 150 on struts 145 and 146, having shock absorbers 147. A main strut 144 with optional additional shock absorber 143 provides added support and resilience to the wheel assembly, and may also permit the wheels 150 and wheel mounts 145 and 146, to swing free from below the frame 120 if a detachable connection is provided where the wheel mounts meet the carriage assembly plate 141.

In FIG. 5, the cart is configured in an operating state in which the carriage assembly 141 is locked by pin 153 in the second lock position 152. In this manner, the wheels are located below the middle of the telescoping frame 120 when it is horizontal, and less force is required to keep the cart horizontal in the operating state.

In FIG. 6, the cart of FIG. 5 is shown in a loading state in which the carriage assembly 141 is locked by pin 153 in the first lock position 151. In this manner, the wheels 150 and the foot end 121 form a tripod base for stable loading of an elongated load onto the cart 100. Once the load is secured in substantially vertical position, the locks at 151 may be released, the carriage assembly slide relative to the carriage guides, and the carriage assembly locked in the operating state at the second lock position 152. Other positions may be provided to facilitate turning of the cart 100 while in use, although in practice these 2 positions are sufficient. Wheel brakes of various sorts, including those used on bicycles, may be used to facilitate changing the state of the cart from the operating state of FIG. 5 to the loading state of FIG. 6. The brakes would be engaged on the wheels and the lock on the carriage guides disengaged to permit the state change. Then, the lock would be reengaged to fix the state, and the brakes would be disengaged to permit operation. A default of having both the wheel brakes and the lock engaged would be considered safe for loading.

The secure repositioning from one state to another may be achieved using various locking means between the carriage assembly and the frame at the stop positions/lock positions, other than merely pin 153. For example, the locking means may be a friction based brake may be the locking means, retractable pins for pin holes at specific locations, abutments which may be levered into/out of place.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A cart comprising:
a. An elongated frame having a foot end, a head end, a top side and a bottom side , and a longitudinal direction from the foot end to the head end, and one or more carriage guides positioned in the longitudinal direction;
b. The carriage guides having a plurality of stop positions;
c. A carriage assembly having wheels, the carriage assembly positioned on the bottom side of the frame in slideable attachment with the frame along the one or more carriage guides; and
d. The carriage assembly capable of secure repositioning at the plurality of stop positions along the carriage guides such that the wheels may be longitudinally repositioned relative to the cart.

2. The cart of claim 1 wherein the secure repositioning is achieved by locking means between the carriage assembly and the frame at the stop positions.

3. The cart of claim 1 wherein wheels are further provided with a braking mechanism connected to a brake activator on the head end of the frame by a brake cable.

4. The cart of claim 1 wherein the carriage guides are cylinders and the carriage assembly is slidably attached thereto by tube shaped guide sleeves which fit around the cylinders.

5. The cart of claim 1 wherein the carriage guides are hollow rail sleeves and the carriage assembly is attached thereto by rail means slidably fitted within the rail sleeves.

6. The cart of claim 1 wherein carriage guides are hollow rail sleeves and the carriable assembly is attached thereto by rail means slidably fitted within the rail sleeves.

7. The cart of claim 1 wherein the top side of the elongated frame is adapted to receive an elongated load from the group of elongated loads consisting of spinal boards, spine boards, rescue stretchers, rescue baskets, fully body vacumn splints and back boards.

8. The cart of claim 7 wherein the frame further comprise pegs adapted to fit into receiving grooves of standardized spinal boards.

9. A cart comprising:
a. An elongated frame defining a foot end, a head end, a top side and a bottom side of the cart, and a longitudinal direction from the foot end to the head end;
b. A carriage assembly having wheels attached to the bottom side of the frame;
c. The carriage assembly having a strut mounted on a hinge towards the foot end, in a manner which permits the strut to rotate in a plane containing the longitudinal direction perpendicular to the bottom side,
d. And one or more wheel mounts affixed to the strut distal from the carriage assembly, the one or more wheel mounts having one or more abutments for biased engagement with the bottom side of the cart when the strut is positioned under the frame.

10. The cart of claim 9 wherein the one or more abutments are shock absorbers.

11. The cart of claim 9 wherein.
a. the frame further comprises one or more carriage guides positioned in the longitudinal direction;
b. the carriage guides having a plurality of stop positions; and
c. the carriage assembly is in slideable attachment with the frame along the one or more carriage guides and capable of secure repositioning at the plurality of stop positions along the carriage guides such that the wheels may be longitudinally repositioned relative to the cart.

12. The cart of claim 11 wherein the secure repositioning is achieved by locking means between the carriage assembly and the frame at the stop positions.

13. The cart of claim 11 the carriage guides are one or more cylinders and the carriage assembly is slidably attached thereto by one or more guide sleeves which fit around such cylinders.

14. The cart of claim 13 wherein the stop positions are any position along the carriage guides and secure repositioning is achieved by activating a friction lock between at least one of the guide sleeves and the cylinder about which it is otherwise slidably attached.

15. The cart of claim 11 wherein wheels are further provided with a braking mechanism connected to a brake activator on the head end of the frame by a brake cable.

16. The cart of claim 11 wherein the top side of the elongated frame is adapted to receive an elongated load from the group of elongated loads consisting of spinal boards, spine boards, rescue stretchers, rescue baskets, fully body vacuum splints and back boards.

17. A cart comprising:
a. An elongated frame defining a foot end, a head end, a top side and a bottom side of the cart, and a longitudinal direction from the foot end to the head end, and one or more carriage guides positioned in the longitudinal direction;
b. A carriage assembly having
i. a plate with carriage guides to slidably attached the carriage assembly to the carriage guides on the bottom side of the frame;
ii. a strut mount hinged to the bottom side of the plate towards the foot end of the cart to permit the strut mount to rotate out from under the frame to lay the frame bottom side on the ground in a non-operating state and to rotate the strut mount back under the frame in an operating state; and
iii. one or more wheel mounts affixed to the strut mount distal from the hinge, the wheel mounts having a shock absorber for biased engagement with the bottom side of the plate when the strut mount is rotated into the operating state;
c. The carriage assembly capable of secure repositioning at a plurality of positions along the one or more carriage guides by way of activation of a position locking mechanism between the carriage assembly and the frame.

18. The cart of claim 17 wherein the top side of the elongated frame is adapted to receive an elongated load from the group of elongated loads consisting of spinal boards, spine boards, rescue stretchers, rescue baskets, fully body vacumn splints and back boards.

19. The cart of claim 18 wherein the frame further comprise pegs adapted to fit into receiving grooves of standardized spinal boards.
